(19) United States
(12) Patent Application Publication
(10) Pub. No.: US 2019/0127812 A1
(43) Pub. Date: May 2, 2019

(54) Inhibition of Sucrose Crystallization Using Glycosides

(71) Applicant: Purdue Research Foundation, West Lafayette, IN (US)

(72) Inventors: Lynne S. Taylor, West Lafayette, IN (US); Lisa J. Mauer, West Lafayette, IN (US); Alpana Thorat, Saint Paul, MN (US)

(73) Assignee: Purdue Research Foundation, West Lafayette, IN (US)

(21) Appl. No.: 16/165,415

(22) Filed: Oct. 19, 2018

Related U.S. Application Data
(60) Provisional application No. 62/580,690, filed on Nov. 2, 2017.

(51) Int. Cl. C13B 50/00; A23L 27/30

(52) U.S. Cl. CPC C13B 50/002; A23V 2002/00; A23L 27/33

(57) ABSTRACT

The present disclosure relates to a novel method of inhibiting sugar crystallization and/or sugar crystal growth with at least one glycoside as the sugar crystallization and/or sugar crystal growth inhibitor, and novel compositions comprising amorphous sugar and at least one glycoside as the sugar crystallization and/or sugar crystal growth inhibitor.

### CROSS REFERENCE

The present U.S. patent application is related to and claims the priority benefit of U.S. Provisional Patent Application Ser. No. 62/580,690, filed Nov. 2, 2017, the contents of which is hereby incorporated by reference in its entirety into the present disclosure.

### TECHNICAL FIELD

The present disclosure relates to a novel method of inhibiting sucrose crystallization and/or sucrose crystal growth with at least one glycoside as the sucrose crystallization and/or sucrose crystal growth inhibitor, and novel compositions comprising amorphous sucrose and at least one glycoside as the sucrose crystallization and/or sucrose crystal growth inhibitor.

### BACKGROUND

This section introduces aspects that may help facilitate a better understanding of the disclosure. Accordingly, these statements are to be read in this light and are not to be understood as admissions about what is or is not prior art.

Amorphous sucrose is advantageous for certain food products for enhanced taste perception, rapid dissolution, and to create desirable (often softer) textures. Various techniques have been used to prepare amorphous sucrose including melt quenching, milling, spray drying, and freeze drying.

However, the metastable nature of the amorphous sucrose frequently leads to crystallization of the amorphous sucrose to the thermodynamically more stable crystalline sucrose over time, which can compromise overall product quality. Therefore, the shelf life of substantially amorphous sucrose systems, such as cotton candy, may be very short.

As a consequence of the broad interest in amorphous sucrose, sucrose crystallization phenomena have been widely studied. Amorphous sucrose is very stable when the water content is low. However, similar to other amorphous systems, moisture sorption can induce physical instability leading to powder caking, plasticization, reduction of the glass transition temperature, and crystallization.

Some studies showed that adding a small percent of another type of sugar to sucrose may extend the shelf life of the amorphous system by slowing crystallization. See Leinen, et al., Crystallization inhibition of an amorphous sucrose system using raffinose. Journal of Zhejiang University. Science. B, 7(2), 85-89, 2006. It was disclosed in Leinen et al. that “the mechanism of inhibition is believed to be the attachment of the sucrose portion of raffinose on the major planar growing surface of the crystal”. It appears from the Leinen et al. publication that sucrose portion of raffinose is essential for the crystallization inhibition of sucrose by raffinose.

Raffinose is a trisaccharide composed of galactose, glucose, and fructose. It can be found in beans, cabbage, Brussels sprouts, broccoli, asparagus, other vegetables, and whole grains. Raffinose can be hydrolyzed to D-galactose and sucrose by the enzyme α-galactosidase (α-GAL), an enzyme not found in the human digestive tract. Because humans do not possess the α-GAL enzyme to break down raffinose, the undigested raffinose passes through the stomach and upper intestine. In the lower intestine, raffinose is fermented by gas-producing bacteria that do possess the α-GAL enzyme and make carbon dioxide, methane, or hydrogen—leading to the flatulence commonly associated with eating beans and other vegetables.

Therefore, there is still a need for novel sucrose crystallization inhibitors and the method of using the novel sucrose crystallization inhibitors.

### SUMMARY

The present disclosure relates to a novel method of inhibiting sucrose crystallization and/or sucrose crystal growth with at least one glycoside as the sucrose crystallization and/or sucrose crystal growth inhibitor, and novel compositions comprising amorphous sucrose and at least one glycoside as the sucrose crystallization and/or sucrose crystal growth inhibitor.

In one embodiment, the present disclosure provides a composition comprising amorphous sucrose and at least one glycoside as a sucrose crystallization and/or sucrose crystal growth inhibitor.

In one embodiment, the present disclosure provides a method of inhibiting sucrose crystallization and/or sucrose crystal growth with at least one glycoside as the sucrose crystallization and/or sucrose crystal growth inhibitor.

### DETAILED DESCRIPTION

For the purposes of promoting an understanding of the principles of the present disclosure, reference will now be made to the embodiments. It will nevertheless be understood that no limitation of the scope of this disclosure is thereby intended.

In the present disclosure the term “about” can allow for a degree of variability in a value or range, for example, within 10%, within 5%, or within 1% of a stated value or of a stated limit of a range.

In the present disclosure the term “substantially” can allow for a degree of variability in a value or range, for example, within 90%, within 95%, or within 99% of a stated value or of a stated limit of a range.

In the present disclosure the term “amorphous” may refer to that the amount of the non-crystal sugar is at least 65 wt % of the total amount of the sugar by weight. In one aspect, the amount of the non-crystal sugar is at least 75 wt %, 80 wt %, 85 wt %, 90 wt %, 95 wt %, 96 wt %, 97 wt %, 98 wt %, or 99 wt % of the total amount of the sugar by weight. In one aspect, the sugar comprises sucrose.

In the present disclosure the term “sugar” may refer to any sweet and water soluble carbohydrates used primarily in food. The term “sugar” may refer to monosaccharide such as glucose or fructose; disaccharide such as sucrose or lactose.

In the present disclosure the term “glycoside” may refer to any material, or a food and/or pharmaceutically acceptable salt thereof, with a chemical structure comprising a carbohydrate (sugar) moiety part and a non-carbohydrate (non-sugar) moiety. The sugar moiety is generally known as the glycone part of a glycoside. The non-sugar moiety is generally known as the aglycone part of a glycoside. The glycone can consist of a single sugar group (monosaccharide) or several sugar groups (oligosaccharide). A glycone moiety and an aglycone may be linked together through an oxygen, sulfur or a nitrogen to form an O-glycoside, an S-glycoside, or an N-glycoside.

Glycosides may be classified by glycone or by aglycone. When a glycoside is classified by glycone, if the glycone group of a glycoside is glucose, then the molecule is a glucoside; if it is fructose, then the molecule is a fructoside. When a glycoside is classified by aglycone, glycosides may be classified according to the chemical nature of the aglycone into glycosides such as alcoholic glycosides, anthraquinone glycosides, coumarin glycosides, cyanogenic glycosides, flavonoid glycosides, phenolic glycosides, steroidal glycosides, steviol glycosides, thioglycosides, hydroxycinnamic acid glycosides.

Flavonoid glycosides, phenolic glycosides, steroidal glycosides, steviol glycosides, and hydroxycinnamic acid glycosides are the more preferred glycosides for the present disclosure. Non-limiting examples of flavonoid glycosides that may be used as a suitable sugar crystallization and/or sugar growth inhibitor include but are not limited to naringin, hesperidin, rutin, quercitrin, pelargonidin 3-glucoside, peonidin 3-rutinoside, quercetin 4′-O-glucoside, kaempferol 3-O-sophoroside, luteolin 7-O-glucuronide, Apigenin-6-arabinodide-8-glucoside, quercetin 3-O-rutinoside, kaempferol 3-O-rutinoside, kaempferol 3-O-glucoside, quercetin 3-O-glucoside, quercetin 3-O-glucosyl-rhamnosyl-glucoside, quercetin 3-O-galactoside, kaempferol 3-O-galactoside, quercetin 3-O-rutinoside, kaempferol 3-O-glucoside, quercetin 3-O-galactoside, kaempferol 3-O-rutinoside, the food/pharmaceutically acceptable salt thereof, or any combination thereof. Non-limiting examples of phenolic glycosides that may be used as a suitable sugar crystallization and/or sugar growth inhibitor include but are not limited to arbutin, salicin, salidroside, the food/pharmaceutically acceptable salt thereof, or any combination thereof. Non-limiting examples of steroidal glycosides that may be used as a suitable sugar crystallization and/or sugar growth inhibitor include but are not limited to glycyrrhizic acid, saponin, oleandrin, proscillaridin, cyclamin, the food/pharmaceutically acceptable salt thereof, or any combination thereof. Non-limiting examples of steviol glycosides that may be used as a suitable sugar crystallization and/or sugar growth inhibitor include but are not limited to stevioside, rebaudioside A, the food/pharmaceutically acceptable salt thereof, or any combination thereof. Non-limiting examples of hydroxycinnamic acid glycosides that may be used as a suitable sugar crystallization and/or sugar growth inhibitor include but are not limited to verbascoside, 1-O-feruloyl-beta-D-glucose, 5-caffeoylquinic acid, 4-caffeoylquinic acid, 3-caffeoylquinic acid, 5-feruloylquinic acid, 4-feruloylquinic acid, 3-feruloylquinic acid, 3,4-dicaffeoylquinic acid, the food/pharmaceutically acceptable salt thereof, or any combination thereof.

Leinen et al. previously disclosed that “the mechanism of inhibition is believed to be the attachment of the sucrose portion of raffinose on the major planar growing surface of the crystal”. It appears from the previous disclosure that sucrose portion of raffinose is essential for the crystallization inhibition of sucrose by raffinose.

The present disclosure not only surprisingly identified that certain non-sugar compounds such as glycosides can effectively inhibit the sucrose crystallization and/or sucrose crystal growth, but also unexpectedly found that even glycosides having a non-sucrose portion can effectively inhibit the sucrose crystallization and/or sucrose crystal growth. This is opposite to mechanism as disclosed by Leinen et al.

In one embodiment, the present disclosure provides a composition comprising an amorphous sugar and at least one glycoside as a sugar crystallization and/or sugar crystal growth inhibitor. In one aspect, the sugar comprises sucrose. In one aspect, the sugar comprises lactose.

In one embodiment, the present disclosure provides a method of inhibiting sugar crystallization and/or sugar crystal growth with at least one glycoside as the sugar crystallization and/or sugar crystal growth inhibitor. In one aspect, the sugar comprises sucrose. The sugar crystallization and/or sugar crystal growth inhibitor is a sucrose crystallization and/or sucrose crystal growth inhibitor.

In one embodiment, the glycoside comprises a flavonoid glycoside, a phenolic glycoside, a steroidal glycoside, a food and/or pharmaceutically acceptable salt thereof, or any combination thereof.

In one embodiment, the glycoside comprises a flavonoid glycoside, or a food and/or pharmaceutically acceptable salt thereof.

In one embodiment, the structure of the glycoside comprises a disaccharide moiety of neohesperidose or a derivative thereof.

In one embodiment, the structure of the glycoside comprises a moiety of an optionally subtitled flavanone or a derivative thereof, wherein the optional substitution group on flavanone or the derivative thereof may be one or more —OH, C1-C4 straight or branched alkyl, halogen, C1-C4 alkoxyl, or any combination thereof.

In one embodiment, the glycoside comprises naringin with the structure of:

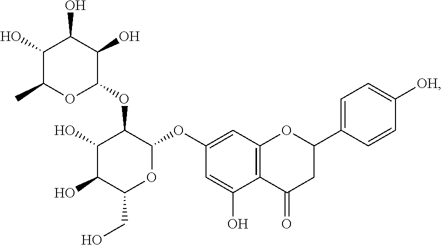 [SMILES: C[C@@H]1O[C@@H](O[C@H]2[C@H](Oc3cc(O)c4c(c3)OC(c3ccc(O)cc3)CC4=O)O[C@H](CO)[C@@H](O)[C@@H]2O)[C@H](O)[C@H](O)[C@H]1O]

or a food and/or pharmaceutically acceptable salt thereof.

In one embodiment, the glycoside comprises steroidal glycoside, or a food and/or pharmaceutically acceptable salt thereof.

In one embodiment, the structure of the glycoside comprises a disaccharide moiety of diglucuronic acid or a derivative thereof.

In one embodiment, the structure of the glycoside comprises a moiety of an optionally subtitled enoxolone or a derivative thereof, wherein the optional substitution group on enoxolone or the derivative thereof may be one or more —OH, C1-C4 straight or branched alkyl, halogen, C1-C4 alkoxyl, or any combination thereof.

In one embodiment, the glycoside comprises glycyrrhizic acid with the structure of:

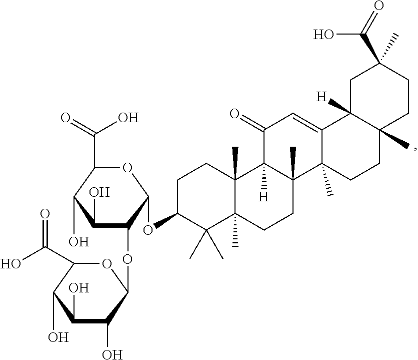

or a food and/or pharmaceutically acceptable salt thereof.

In one embodiment, the weight percentage of the amorphous sugar is 75.0-99.9% of the total weight of the amorphous sugar and the glycoside, the weight percentage of the glycoside is 0.1-25.0% of the total weight of the amorphous sugar and the glycoside. In one aspect, the weight percentage of the amorphous sugar is 90-99.9%, the weight percentage of the glycoside is 0.1-10.0% of the total weight of the amorphous sugar and the glycoside. In one aspect, the weight percentage of the amorphous sugar is 95-99.9%, the weight percentage of the glycoside is 0.1-5.0% of the total weight of the amorphous sugar and the glycoside. In one aspect, the sugar comprises sucrose.

In one embodiment, the present disclosure provides that the glycoside as the sugar crystallization and/or sugar crystal growth inhibitor maintains all or a substantial amount of sugar in amorphous form for at least 10 days under the condition of about 23% relative humidity (RH) and 25-40° C. In one aspect, for at least 15 days, 20 days, 25 days, or 30 days.

In one embodiment, the present disclosure provides that the glycoside as the sugar crystallization and/or sugar crystal growth inhibitor maintains all or a substantial amount of sugar in amorphous form for at least 10 days under the condition of about 33% relative humidity (RH) and about 25° C. In one aspect, for at least 15 days, 20 days, 25 days, or 30 days.

Materials

Sucrose (98% pure based on gas chromatographic analysis) was purchased from Sigma-Aldrich (St. Louis, Mo.) and was used for all experiments without further purification. Glycyrrhizic acid ammonium salt from glycyrrhiza root (licorice) (GA), and Naringin (N) were purchased from Sigma Aldrich (St. Louis, Mo.). Phosphorus (V) Oxide (P₂O₅) was purchased from VWR Scientific Products (Radnor, Pa.). Inorganic salts, lithium chloride, potassium acetate, and magnesium chloride, were purchased from Fischer Scientific (Waltham, Mass.). Karl Fischer reagents (HYDRANAL™-Methanol Rapid (titrant), and HYDRANAL™-Methanol Rapid (working medium)) for volumetric titration were purchased from Sigma-Aldrich (St. Louis, Mo.). Water used in this study was processed by reverse osmosis followed by filtration through Barnstead E-pure Lab Water Systems (Dubuque, Iowa).

Preparation of Amorphous Samples

All samples were prepared by freeze drying solutions containing 10-11% total weight solids of sucrose alone or sucrose-glycoside mixtures. The sucrose-glycoside mixtures contained 1 or 5 wt % of the glycoside relative to sucrose (Table 1). Solutions were frozen at −40° C. and 300 mTorr for 6 h in a VirTis Genesis 25ES shelf freeze dryer (SP Scientific, Stone Ridge, N.Y.) prior to lyophilization. Primary drying was then carried out at 150 mTorr and −40° C. for 24 h followed by secondary drying where the temperature was increased in 10° C. increments from −40° C. to +20° C. with a 9 h hold for each step. An additional heating step was carried out for 6 h at +25° C. and 300 mTorr and then samples were immediately transferred to desiccators filled with phosphorous pentoxide (P₂O₅) (˜0% RH) and stored at 23±2° C. until used for further analysis.

Storage Treatments

Samples were stored at different relative humidities (RHs) in desiccators containing P₂O₅ (˜0% RH) or saturated salt solutions of lithium chloride (11% RH), potassium acetate (23% RH), or magnesium chloride (33% RH). Samples were placed at room temperature, 23±2° C., or 40° C. in temperature controlled incubators. A single desiccator was used for each sample stored at different RH and temperature conditions. Separate samples were prepared for each time point. After removing samples and conducting Powder X-Ray Diffraction (PXRD) analysis, samples were discarded.

Powder X-Ray Diffraction (PXRD) Analysis

Diffractograms were obtained to evaluate the crystallization of lyophiles as a function of time following storage at different environmental conditions, and to obtain reference patterns of crystalline sucrose and the novel additives. Powder X-ray diffraction (PXRD) analysis was carried out using a Rigaku Smartlab diffractometer (The Woodlands, Tex.) with a Cu—Kα radiation source in Bragg-Bretano geometry and operating at 40 kV and 40 mV. Measurements were performed from 5-40° 2θ with a scan speed of 15°/min at a 0.02° step size. XRD patterns of all starting crystalline materials and all lyophiles were obtained. Triplicate samples of the lyophiles were analyzed by PXRD on days 0, 7, 14, 21, and 30. Samples showing evidence of crystallinity on day 7 were further evaluated by preparing fresh samples and analyzing on days 1, 2, and 4 to better identify the onset of crystallization. Samples were considered to be XRD amorphous when halo diffractogram patterns with no peaks significantly above the noise level were observed. Crystallization was identified by the presence of reflections characteristic of crystalline sucrose and the crystalline naringin. Glycyrrhizic acid ammonium salt was amorphous, hence samples containing GA were only evaluated for the presence or absence of sucrose crystalline peaks.

Dynamic Vapor Sorption

Moisture sorption profiles of all lyophiles were generated using a SPSx-1μ Dynamic Vapor Sorption Analyzer (Projekt Messtechnik, Ulm, Germany) at 25° C. Samples (150 to 200 mg of lyophile) were placed in aluminum pans in a 24-ring sample holder and equilibrated at 0% RH and 25° C. for 96 h in the instrument. Samples were also analyzed at a constant RH of 40% RH for 96 h and an equilibration end point criterion of <0.001% weight change within 15 min. The % dm (change in mass) at 40% RH was then plotted versus time to obtain moisture sorption/desorption over time profiles for different lyophiles.

Moisture Content

The moisture contents of all lyophiles following storage in desiccators containing P₂O₅ (0% RH) for 7 days, and in desiccators containing magnesium chloride (33% RH) for 16 h at 23° C. were determined using one component volumetric titration Karl Fischer analysis (Mettler Toledo V20 Volumetric Karl Fisher KF Titrator, Mettler Toledo LLC. Columbus, Ohio). Briefly, 200 to 300 mg of a lyophile was directly added to the working medium (HYDRANAL™-Methanol Rapid) and stirred for one minute to extract water. The sample was then titrated using HYDRANAL™-Composite 2 titrant, and the water content (%) was estimated using the HYDRANAL™-Water Standard 10 (10 mg/g water content).

Results:

Physical Stability of Freeze Dried Sucrose and Glycosides

Table 1: Physical stability of freeze dried sucrose and novel additives during storage in controlled temperature and relative humidity (RH) conditions for 1 month. Samples that remained amorphous are marked “A”, otherwise the length of time prior to crystallization evident as peaks in PXRD patterns is noted.

| | Storage Conditions (RH and Temperature) | | | | | | | |
|---|---|---|---|---|---|---|---|---|
| | 11% RH | | 23% RH | | | 33% RH | | |
| Sample Name | 25° C. | 40° C. | 25° C. | 40° C. | | 25° C. | | 40° C. |
| Sucrose | A | A | A | 1 | day | 7 | days | 1 day |
| Sucrose + Licorice 1% | A | A | A | A | | 15 | days | 1 day |
| Sucrose + Licorice 5% | A | A | A | A | | A | | 1 day |
| Sucrose + Naringin 1% | A | A | 30 days | 30 | days | 21 | days | 1 day |

| | | | | | | |
|---|---|---|---|---|---|---|
| Sucrose + Naringin 5% | A | A | A | A | A | 1 day |

It is apparent from the data presented in Table 1 that sucrose crystallizes quickly at room temperature and 33% RH, with crystallization being observed within a week. In contrast, with the added glycosides as crystallization inhibitors, the samples are still amorphous after one month at the same conditions. These data demonstrated that the glycosides can serve as sucrose crystallization inhibitors. They are thus a potentially important new group of compounds that could be used to prepare and stabilize amorphous sucrose. In turn, amorphous sucrose has advantageous properties for numerous food product applications.

Those skilled in the art will recognize that numerous modifications can be made to the specific implementations described above. The implementations should not be limited to the particular limitations described. Other implementations may be possible.

We claim:

1. A composition comprising an amorphous sugar and at least one glycoside or a food and/or pharmaceutically acceptable salt thereof as a sugar crystallization and/or sugar crystal growth inhibitor.

2. The composition of claim 1, wherein the sugar is sucrose.

3. The composition of claim 1, wherein the at least one glycoside is a flavonoid glycoside, a phenolic glycoside, a steroidal glycoside, a steviol glycoside, a hydroxycinnamic acid glycoside, or a food and/or pharmaceutically acceptable salt thereof.

4. The composition of claim 1, wherein the glycoside has a structure comprising a disaccharide moiety of neohesperidose, diglucuronic acid, or a derivative thereof.

5. The composition of claim 1, wherein the glycoside has a structure comprising a moiety of an optionally subtitled flavanone or a derivative thereof, wherein the optional substitution group on the flavanone or the derivative thereof may be one or more —OH, C1-C4 straight or branched alkyl, halogen, C1-C4 alkoxyl, or any combination thereof.

6. The composition of claim 1, wherein the glycoside has a structure comprising a moiety of an optionally subtitled enoxolone or a derivative thereof, wherein the optional substitution group on enoxolone or the derivative thereof may be one or more —OH, C1-C4 straight or branched alkyl, halogen, C1-C4 alkoxyl, or any combination thereof.

7. The composition of claim 1, wherein the at least one glycoside is selected from the group consisting of naringin, hesperidin, rutin, quercitrin, pelargonidin 3-glucoside, peonidin 3-rutinoside, quercetin 4′-O-glucoside, kaempferol 3-O-sophoroside, luteolin 7-O-glucuronide, Apigenin-6-arabinodide-8-glucoside, quercetin 3-O-rutinoside, kaempferol 3-O-rutinoside, kaempferol 3-O-glucoside, quercetin 3-O-glucoside, quercetin 3-O-glucosyl-rhamnosyl-glucoside, quercetin 3-O-galactoside, kaempferol 3-O-galactoside, quercetin 3-O-rutinoside, kaempferol 3-O-glucoside, quercetin 3-O-galactoside, kaempferol 3-O-rutinoside, arbutin, salicin, salidroside, glycyrrhizic acid, saponin, oleandrin, proscillaridin, cyclamin, stevioside, rebaudioside A, verbascoside, 1-O-feruloyl-beta-D-glucose, 5-caffeoylquinic acid, 4-caffeoylquinic acid, 3-caffeoylquinic acid, 5-feruloylquinic acid, 4-feruloylquinic acid, 3-feruloylquinic acid, 3,4-dicaffeoylquinic acid, the food/pharmaceutically acceptable salt thereof, and any combination thereof.

8. The composition of claim 1, wherein the glycoside is naringin with the structure of: 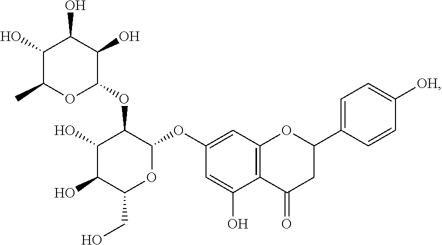 [SMILES: C[C@@H]1O[C@@H](O[C@H]2[C@H](Oc3cc(O)c4c(c3)OC(c3ccc(O)cc3)CC4=O)O[C@H](CO)[C@@H](O)[C@@H]2O)[C@H](O)[C@H](O)[C@H]1O]
or a food and/or pharmaceutically acceptable salt thereof.

9. The composition of claim 1, wherein the glycoside is glycyrrhizic acid with the structure of: 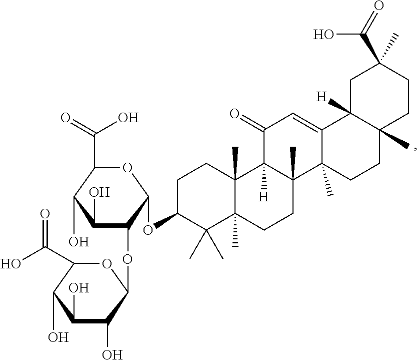
or a food and/or pharmaceutically acceptable salt thereof.

10. The composition of claim 1, wherein the weight percentage of the amorphous sugar is 75.0-99.9% of the total weight of the amorphous sugar and the glycoside, the weight percentage of the glycoside is 0.1-25.0% of the total weight of the amorphous sugar and the glycoside.

11. A method of inhibiting crystallization and/or crystal growth of a readily crystallizable sugar, wherein the method comprises the use of a glycoside or a food and/or pharmaceutically acceptable salt thereof as a sugar crystallization and/or sugar crystal growth inhibitor.

12. The method of claim 11, wherein the sugar is sucrose.

13. The method of method 11, wherein the glycoside is a flavonoid glycoside, a phenolic glycoside, a steroidal glycoside, or a food and/or pharmaceutically acceptable salt thereof.

14. The method of method 11, wherein the glycoside is naringin with the structure of: 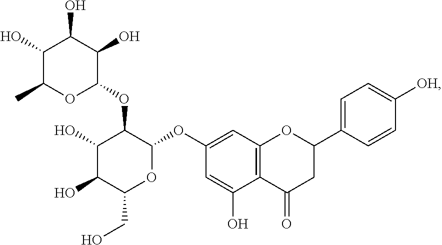 [SMILES: C[C@@H]1O[C@@H](O[C@H]2[C@H](Oc3cc(O)c4c(c3)OC(c3ccc(O)cc3)CC4=O)O[C@H](CO)[C@@H](O)[C@@H]2O)[C@H](O)[C@H](O)[C@H]1O]
or a food and/or pharmaceutically acceptable salt thereof.

15. The method of claim 11, wherein the glycoside is glycyrrhizic acid with the structure of: 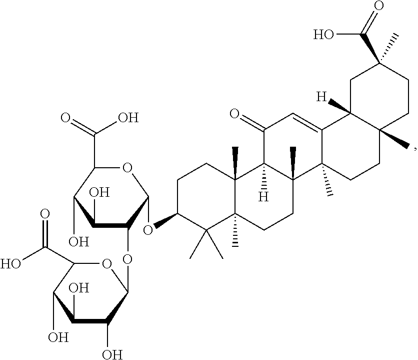
or a food and/or pharmaceutically acceptable salt thereof.
